(19) United States
(12) Patent Application Publication
(10) Pub. No.: US 2014/0203743 A1
(43) Pub. Date: Jul. 24, 2014

(54) DRIVE APPARATUS AND DRIVE METHOD FOR BRUSHLESS MOTOR

(71) Applicant: HITACHI AUTOMOTIVE SYSTEMS, LTD., Hitachinaka-shi (JP)

(72) Inventor: Naoki OKAMOTO, Isesaki-shi (JP)

(73) Assignee: HITACHI AUTOMOTIVE SYSTEMS, LTD., Hitachinaka-shi (JP)

(21) Appl. No.: 14/039,681

(22) Filed: Sep. 27, 2013

(30) Foreign Application Priority Data
Jan. 18, 2013 (JP) 2013-007085

(51) Int. Cl. H02P 6/14

(52) U.S. Cl. CPC H02P 6/145
USPC 318/400.14

(57) ABSTRACT

The present invention relates to a drive apparatus that drives a brushless motor with a square wave, and relates to a drive method thereof. The drive apparatus limits a duty cycle of once in N times of pulse width modulation periods so that the duty cycle does not fall below a set value, and increases the N value according to a rotation speed of the brushless motor, and then obtains position information in a period in which the duty cycle is limited to the predetermined duty cycle. Then, when the rotation speed cannot be decreased to a target rotation speed even when an average duty cycle is decreased to a limit, electric angles of a switching period of an energization pattern are switched from 60 degrees to 120 degrees.

### BACKGROUND OF THE INVENTION

1. Field of the Invention

The present invention relates to a drive apparatus that drives a three-phase brushless motor in a sensorless manner, and relates to a drive method therefor.

2. Description of Related Art

Japanese Laid-open (Kokai) Patent Application Publication No. 2009-189176 discloses a drive system for a synchronous motor that detects an induced voltage of a non-energized phase induced by a pulse voltage, in a three-phase synchronous electric motor, and compares the induced voltage with a reference voltage, to sequentially switch energization patterns according to the comparison result.

The pulse induced voltage of the non-energized phase is detected while a pulse voltage is applied to two phases. However, immediately after start of voltage application, the pulse induced voltage varies. Therefore, if a duty cycle of the pulse voltage is small, the pulse induced voltage in a period in which the pulse induced voltage varies might be sampled, and hence, the pulse induced voltage might be erroneously detected, and a switching timing of energization patterns might be erroneously decided.

Moreover, a level of the pulse induced voltage in the non-energized phase varies according to the duty cycle of the pulse voltage. Consequently, if the duty cycle is small, the voltage decreases below a voltage detection resolution, and hence, decision of the energization-pattern switching timing may not be performed.

However, the duty cycle needs to be small in order to decrease a rotation speed of a brushless motor, and thus, it is difficult to decrease the rotation speed while suppressing an occurrence of a loss of synchronism.

### SUMMARY OF THE INVENTION

It is therefore an object of the present invention to provide a drive device that drives the brushless motor at a low rotation speed while suppressing the occurrence of the loss of synchronism in the brushless motor, and a drive method thereof.

In order to achieve the above object, according to an aspect of the present invention, a drive apparatus for a brushless motor includes: a driving unit that switches two phases according to position information based on a pulse induced voltage induced in a non-energized phase, the two phases being selected from three phases of the brushless motor and to be applied with a pulse voltage according to a pulse width modulation signal; and a period changing unit that changes an electric angle of a switching period of phases to which the pulse voltage is applied, according to a rotation speed of the brushless motor.

Furthermore, according to an aspect of the present invention, a drive method for a brushless motor includes the steps of: switching two phases according to position information based on a pulse induced voltage induced in a non-energized phase, the two phases being selected from three phases of the brushless motor and to be applied with a pulse voltage according to a pulse width modulation signal; and changing an electric angle of a switching period of phases to which the pulse voltage is applied, according to a rotation speed of the brushless motor.

Other objects and features of aspects of the present invention will be understood from the following description with reference to the accompanying drawings.

### BRIEF DESCRIPTION OF THE DRAWINGS

FIG. 1 is a block diagram illustrating a configuration of an oil hydraulic pump system, according to an embodiment of the present invention;

FIG. 2 is a circuit diagram illustrating configurations of a control unit and a brushless motor, according to an embodiment of the present invention;

FIG. 3 is a flowchart illustrating switching control of cycle modes, according to an embodiment of the present invention;

FIG. 4 is a flowchart illustrating switching control of cycle modes, according to an embodiment of the present invention;

FIG. 5 is a diagram illustrating characteristics of an N value and a minimum value of an average duty cycle with respect to a rotation speed of a brushless motor, according to an embodiment of the present invention;

FIGS. 6A and 6B are timing diagrams each illustrating a detecting timing of position information, according to an embodiment of the present invention;

FIG. 7 is diagram illustrating a relationship between detection of position information and a duty cycle, according to an embodiment of the present invention;

FIG. 8 is a diagram for explaining a limit of decrease in a rotation speed according with respect to a duty cycle, according to an embodiment of the present invention;

FIG. 9 is a flowchart illustrating setting control of a duty cycle for each PWM period, according to an embodiment of the present invention;

FIG. 10 is a diagram illustrating switching characteristics of energization patterns for each cycle mode, according to an embodiment of the present invention;

FIG. 11 is a diagram illustrating torque characteristics for each cycle mode, according to an embodiment of the present invention;

FIG. 12 is a diagram illustrating relationships between a minimum value of an average duty cycle and a cycle mode, according to an embodiment of the present invention;

FIG. 13 is a flowchart illustrating switching control of cycle modes and changing control of a duty cycle, according to an embodiment of the present invention;

FIG. 14 is a flowchart illustrating switching control of cycle modes and changing control of a duty cycle, according to an embodiment of the present invention;

FIG. 15 is a diagram illustrating torque characteristics for each cycle mode, according to an embodiment of the present invention;

FIG. 16 is a flowchart illustrating control of switching timing of energization patterns in a cycle mode CM120, according to an embodiment of the present invention;

FIG. 17 is a flowchart illustrating switching control of detection frequencies and a cycle-mode switching control for each detection frequency, according to an embodiment of the present invention;

FIG. 18 is a flowchart illustrating a three-step switch of detection frequencies and switching control of cycle mode for each detection frequency, according to an embodiment of the present invention;

FIG. 19 is a flowchart illustrating a three-step switch of detection frequencies and switching control of cycle mode for each detection frequency, according to an embodiment of the present invention;

FIG. 20 is a diagram illustrating relationships between a three-step switch of detection frequencies and a minimum value of an average duty cycle, according to an embodiment of the present invention;

FIG. 21 is a flowchart illustrating control in which a switch of cycle modes of a brushless motor is carried out according to a rotation variation, according to an embodiment of the present invention;

FIG. 22 is a flowchart illustrating control in which a switch of cycle modes of a brushless motor is carried out according to a rotation variation, according to an embodiment of the present invention; and

FIG. 23 is a flowchart illustrating detecting control of a rotation variation, according to an embodiment of the present invention.

### DESCRIPTION OF THE PREFERRED EMBODIMENTS

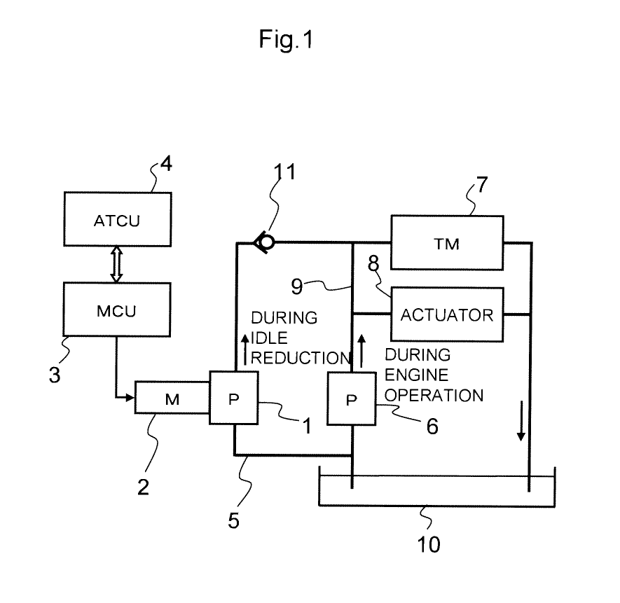

FIG. 1 is a block diagram illustrating an oil hydraulic pump system for a vehicle automatic transmission, to which a drive apparatus for a brushless motor is applied.

The oil hydraulic pump system illustrated in FIG. 1 is provided with a mechanical oil pump 6 driven by an output of an engine (not shown), and a motor-driven electric oil pump 1, serving as oil pumps that supply oil to a transmission 7 and an actuator 8.

Here, for example, electric oil pump 1 is operated when the engine is stopped due to an idle reduction, and then supplies oil to transmission 7 and actuator 8, to suppress a decrease in oil pressure during the idle reduction.

Electric oil pump 1 is driven by a brushless motor 2, which is a three-phase synchronous electric motor, and brushless motor 2 is controlled by a motor control unit 3 based on a command from an AT control unit 4. Motor control unit 3 is a drive apparatus which drives brushless motor 2.

Electric oil pump 1 driven by brushless motor 2 supplies oil in an oil pan 10 to transmission 7 and actuator 8 via an oil pipe 5.

During operation of the engine, mechanical oil pump 6 driven by the engine is operated, so that oil is supplied from mechanical oil pump 6 to the transmission 7 and the actuator 8. At that time, brushless motor 2 is stopped and a check valve 11 blocks off the flow of oil toward electric oil pump 1.

On the other hand, when the engine is stopped by idle reduction, mechanical oil pump 6 is stopped, thereby decreasing the oil pressure in oil pipe 9, and thus, AT control unit 4 transmits a motor startup command to motor control unit 3 in synchronization with engine shutdown by idle reduction.

Upon reception of the motor startup command, motor control unit 3 starts up brushless motor 2 to rotate electric oil pump 1, thereby starting pressure feed of oil by electric oil pump 1.

Then, when discharge pressure of mechanical oil pump 6 decreases and discharge pressure of electric oil pump 1 exceeds a set pressure, check valve 11 opens, so that oil circulates through a route of oil pipe 5, electric oil pump 1, check valve 11, transmission 7, actuator 8, and oil pan 10.

The brushless motor may be, for example, a brushless motor which drives an electric water pump used for circulating engine coolant in a hybrid vehicle. Thus, the equipment driven by the brushless motor is not limited to the oil pump, or the brushless motor is not limited to the motor mounted in the vehicle.

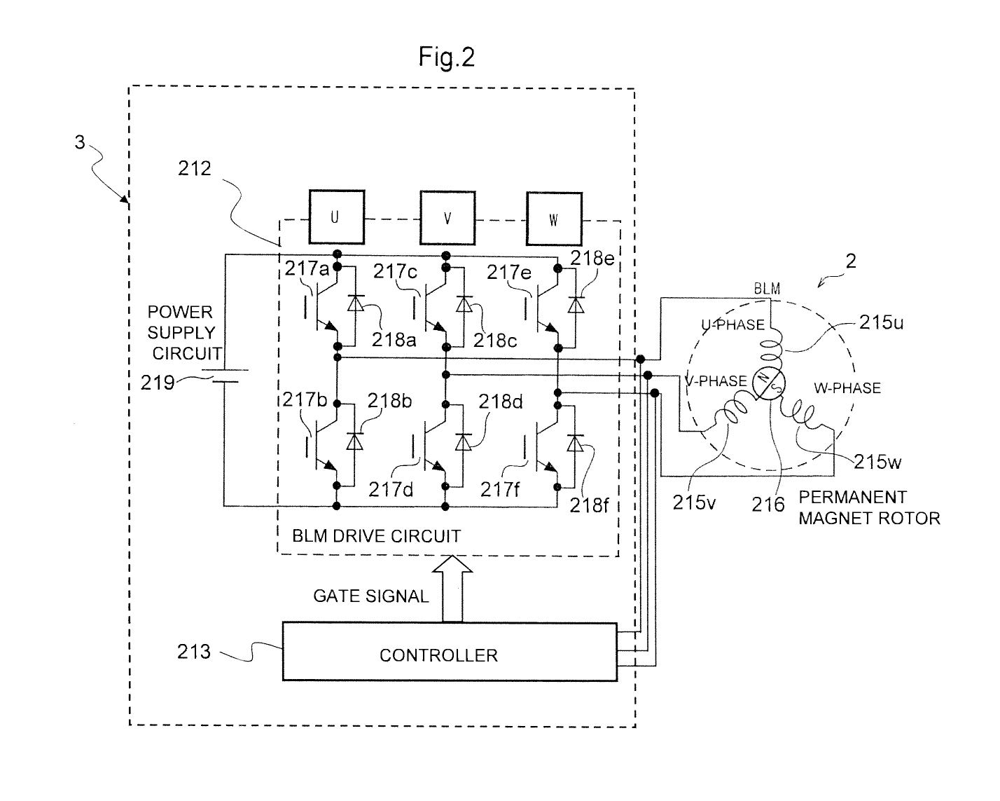

FIG. 2 is a circuit diagram illustrating an example of brushless motor 2 and motor control unit 3.

Motor control unit 3 is provided with a motor drive circuit 212 and a controller 213 including a microcomputer, controller 213 communicating with AT control unit 4.

Brushless motor 2 is a three-phase DC brushless motor, that is, a three-phase synchronous electric motor. Brushless motor 2 includes three-phase coils 215u, 215v, and 215w of a U-phase, a V-phase, and a W-phase in a cylindrical stator (not shown), and a permanent magnet rotor 216 that is rotatable in a space formed at the center of the stator.

Motor drive circuit 212 includes a circuit including three-phase bridge-connected switching elements 217a to 217f including antiparallel diodes 218a to 218f, and a power supply circuit 219. Switching elements 217a to 217f are formed of, for example, FETs.

Gate terminals of switching elements 217a to 217f are connected to controller 213, and controller 213 controls the ON and OFF of switching elements 217a to 217f by pulse width modulation PWM.

Controller 213 performs drive control of brushless motor 2 in a sensorless manner, in which a sensor for detecting position information of the rotor is not used, and furthermore, controller 213 switches between sine wave drive and square wave drive according to the motor rotation speed.

The sine wave drive is a drive method which drives brushless motor 2 by applying a sine wave voltage to each phase. In the sine wave drive, while controller 213 obtains the position information of the rotor based on an induced voltage generated due to rotation of the rotor, that is, a speed electromotive voltage, controller 213 estimates a position of the rotor based on the motor rotation speed during a detecting period of the rotor position based on the speed electromotive voltage, to calculate a three-phase output value based on the estimated rotor position and a duty cycle, so that the direction and magnitude of electric current is controlled based on a phase-to-phase difference in voltage, to thereby allow a three-phase alternating current to flow.

Furthermore, the square wave drive is a drive method which drives brushless motor 2 by sequentially switching, according to the predetermined switching timing, two phases to be applied with a pulse voltage selected from the three phases. In the square wave drive, controller 213 obtains the position information of the rotor based on an induced voltage of a non-energized phase induced by applying a pulse voltage to energized phases, that is, a pulse induced voltage, to detect a switching timing of energization patterns, which are selection patterns of two phases which are to be applied with the pulse voltage.

Here, since an output level of the speed electromotive voltage, which is detected for the position detection in the sine wave drive, decreases as the motor rotation speed decreases, an accuracy of the position detection is decreased in a low rotation speed area. On the other hand, by the pulse induced voltage which is detected for the position detection in the square wave drive, the position information can be detected even in the low rotation speed area, including a motor shutdown state.

Thus, controller 213 drives brushless motor 2 by the sine wave drive in a high rotation speed area in which the position information can be detected in a sufficient accuracy by the sine wave drive, and drives brushless motor 2 by the square wave drive in the low rotation speed area in which the position information cannot be detected in a sufficient accuracy by the sine wave drive.

Hereunder, the square wave drive, which is a feature of the present invention, will be described in detail.

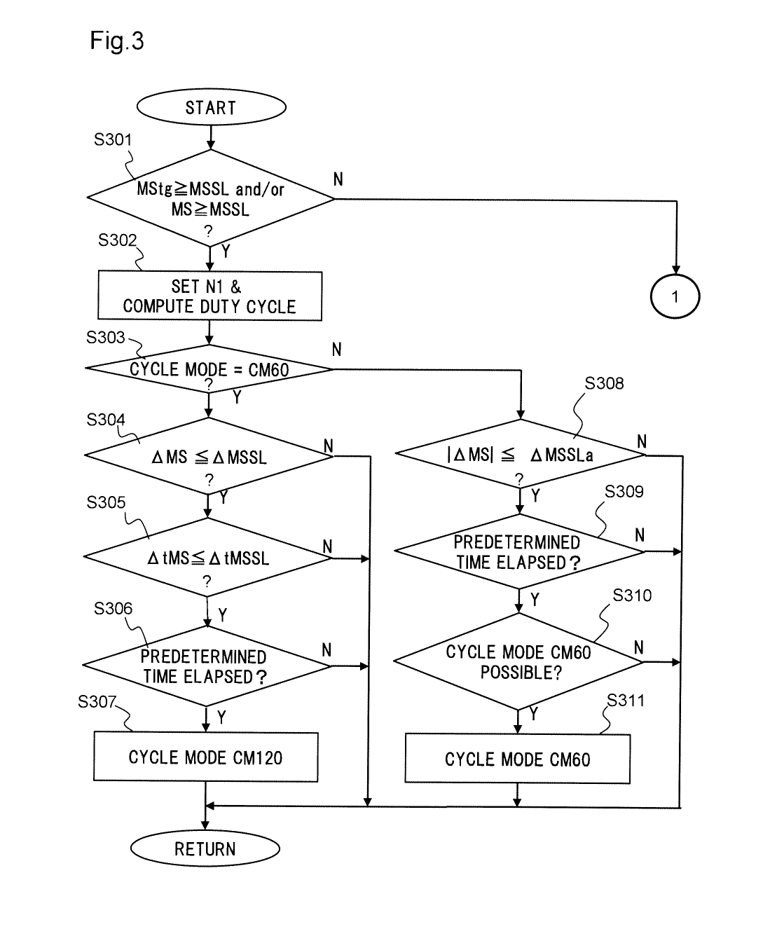

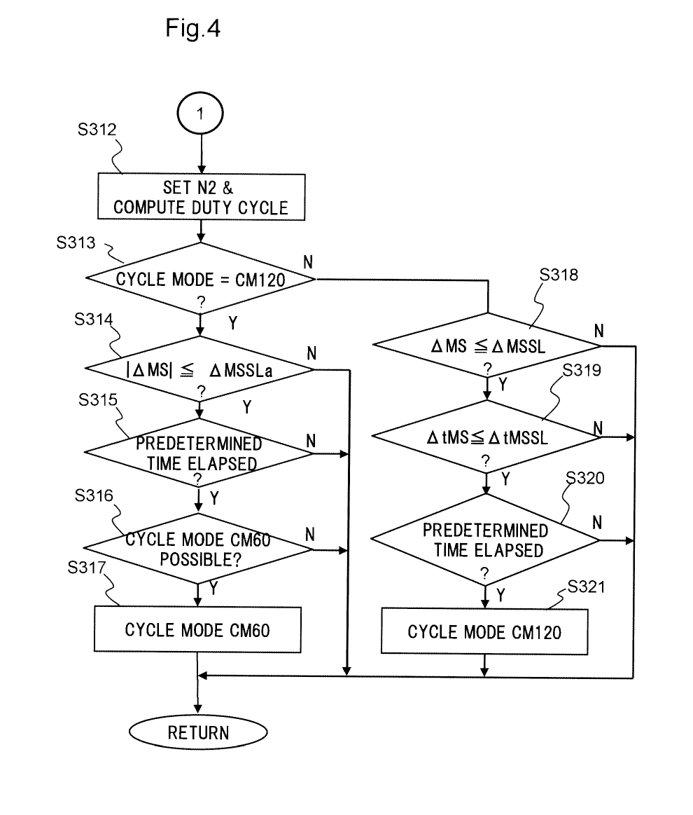

Flowcharts of FIGS. 3 and 4 illustrate flows of square wave drive control of controller 213. A routine illustrated in the flowcharts of FIGS. 3 and 4 is interruptedly performed at predetermined short time intervals by controller 213.

In the flowcharts of FIGS. 3 and 4, in step S301, controller 213 decides whether or not at least one of a target motor rotation speed MStg and an actual motor rotation speed MS is equal to or greater than a set rotation speed MSSL.

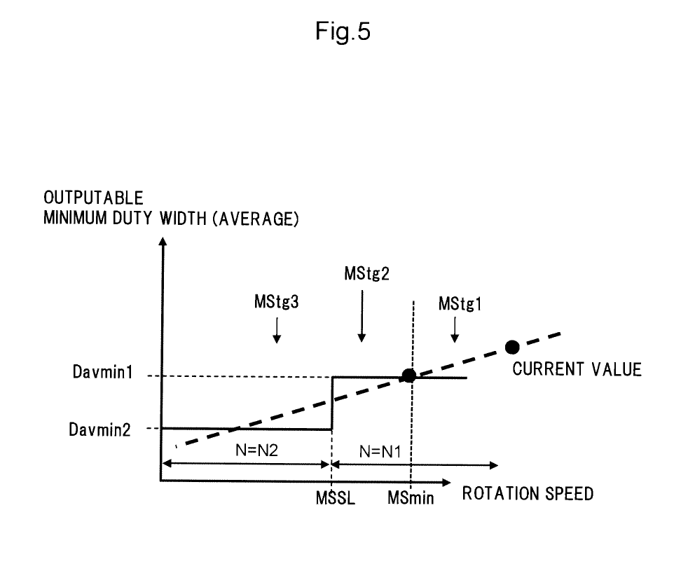

Set rotation speed MSSL is a threshold of motor rotation speed MS at which detection frequencies of the position information of the rotor are switched. As illustrated in FIG. 5, controller 213 sets an N value, which defines the detection frequency (N is an integer, and N≧1), to N1 in a rotation speed area in which motor rotation speed MS is greater than set rotation speed MSSL, and sets the N value to N2 (N1<N2) in a rotation speed area in which motor rotation speed MS is less than set rotation speed MSSL.

Here, settings of the detection frequency of the position information will be described in detail.

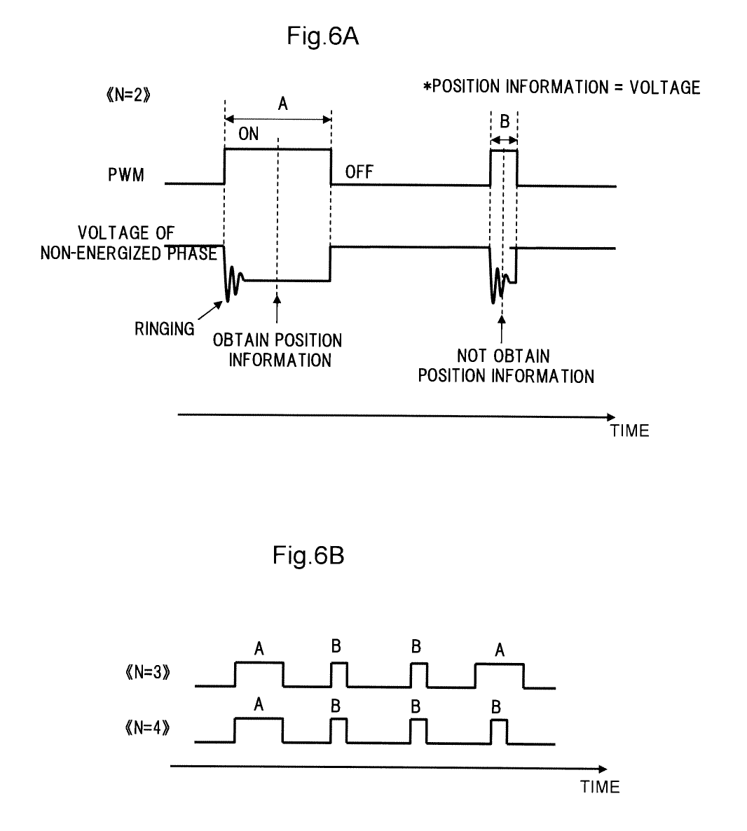

As illustrated in FIGS. 6A and 6B, the detection frequency of the position information of the rotor is defined as a value of N, wherein the detection of the position information is performed once in N times of PWM periods.

Here, when N=1, a position of the rotor is detected at each PWM period, and when N=2, it is to be repeated that after the last position detection of the rotor, the position detection of the rotor is stopped for one period, and then the position detection of the rotor is performed at the next period, as illustrated in FIG. 6A.

Furthermore, when N=3, as illustrated in FIG. 6B, it is to be repeated that after the last position detection of the rotor, the position detection of the rotor is stopped for two periods, and then the position detection of the rotor is performed at the next period. Still further, when N=4, as illustrated in FIG. 6B, it is to be repeated that after the last position detection of the rotor, the position detection of the rotor is stopped for three periods, and then the position detection of the rotor is performed at the next period. Thus, the more a value of N increases, the more the detection frequency of the position information decreases.

In the square wave drive, as mentioned above, controller 213 obtains the position information of the rotor based on the pulse induced voltage induced in the non-energized phase by applying the pulse voltage to the energized phases. However, since the pulse induced voltage varies immediately after the voltage application, it is necessary to avoid the period in which the variation is caused, when controller 213 detects the pulse induced voltage. Furthermore, when the duty cycle (%) is small, the pulse induced voltage may become a voltage which decreases below a voltage detection resolution, and hence, controller 213 may not perform a decision of energization-pattern switching timing.

Thus, controller 213 sets a lower limit DminA of the duty cycle in which the voltage detection can be performed except a period when the variation occurs, and in which the pulse induced voltage exceeding the voltage detection resolution can be generated. Accordingly, no energization control is performed in a duty cycle which decreases below lower limit DminA.

However, when the duty cycle for each PWM period is limited to be equal to or greater than lower limit DminA, the motor rotation speed obtained when the duty cycle is set to lower limit DminA becomes the lowest rotation speed of brushless motor 2, so that the motor rotation speed cannot be decreased below the lowest rotation speed.

Thus, controller 213 does not obtain the position information of the rotor at every PWM period, but controller 213 sets a period at which the position information of the rotor is obtained and a period at which the position information of the rotor is not obtained, to reduce the detection frequency. Then, it is set that the duty cycle in the period at which the position information is not obtained can be set below lower limit DminA, and accordingly, while obtaining the position information, the duty cycle can be averagely decreased below lower limit DminA, to further decrease the motor rotation speed.

For example, as illustrated in FIG. 6A, when N=2, a setting in which a duty cycle A=DminA and a setting in which a duty cycle B<DminA are switched every PWM period, so that the position information of the rotor is obtained when duty cycle A=DminA, and the position information of the rotor is not obtained when duty cycle B<DminA, and thus, the position information of the rotor is obtained once in twice of the PWM periods.

In this case, since the position information of the rotor is obtained in the period in which duty cycle A is set to lower limit DminA, the voltage detection can be performed except in a period in which the pulse induced voltage varies, and the pulse induced voltage which exceeds the voltage detection resolution can be generated, and thus, controller 213 can detect the position of the rotor with sufficient accuracy.

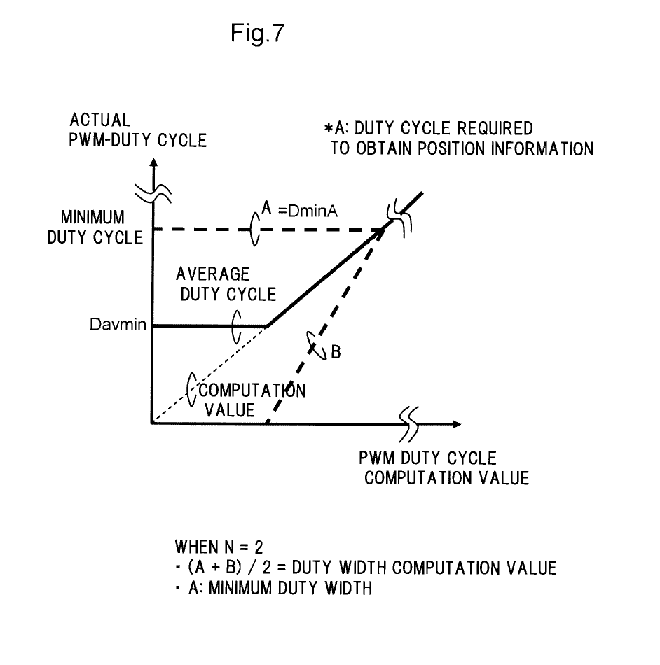

On the other hand, as illustrated in FIG. 7, since duty cycle B in which the position detection is not performed is set to a duty cycle which is less than lower limit DminA, an average duty cycle can be set to a duty cycle which is less than lower limit DminA, and thus, the average duty cycle at the time duty cycle B in which the position detection is not performed is set to 0% becomes an achievable minimum value Davmin of the average duty cycle, and accordingly, when N=2, DminA/2 becomes minimum value Davmin.

Similarly, when N=3, achievable minimum value Davmin becomes Davmin=DminA/3.

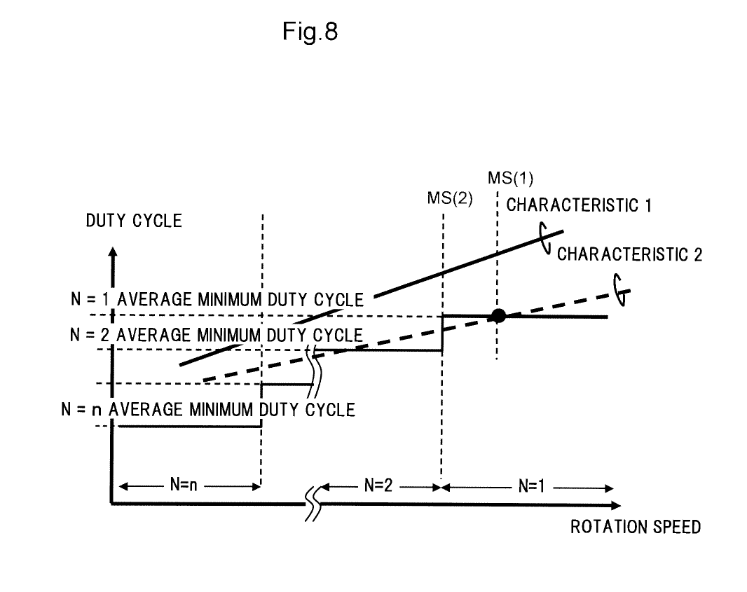

The switching period (ms) of the energization pattern based on the position information of the rotor increases as the rotation speed of brushless motor 2 decreases, and an obtaining period of the position information of the rotor can be increased as the motor rotation speed decreases. Accordingly, as illustrated in FIG. 8, by increasing the N value to decrease the detection frequency of the position information as the motor rotation speed decreases, and by decreasing minimum value Davmin, the motor rotation speed can be further decreased.

In step S301, controller 213 decides whether or not at least one of target motor rotation speed MStg and actual motor rotation speed MS is equal to or greater than set rotation speed MSSL, to switch the detection frequencies (N values).

Then, when at least one of target motor rotation speed MStg and actual motor rotation speed MS is equal to or greater than set rotation speed MSSL, the operation proceeds to step S302, in which controller 213 sets the N value which defines the detection frequency to N1 (N1≧1), to decide the duty cycle for each PWM period according to the detection frequency N1.

In contrast, when both of target motor rotation speed MStg and actual motor rotation speed MS are less than set rotation speed MSSL, the operation proceeds to step S312, in which controller 213 sets the N value which defines the detection frequency to N2 (N2>N1≧1), to decide the duty cycle for each PWM period according to the detection frequency N2.

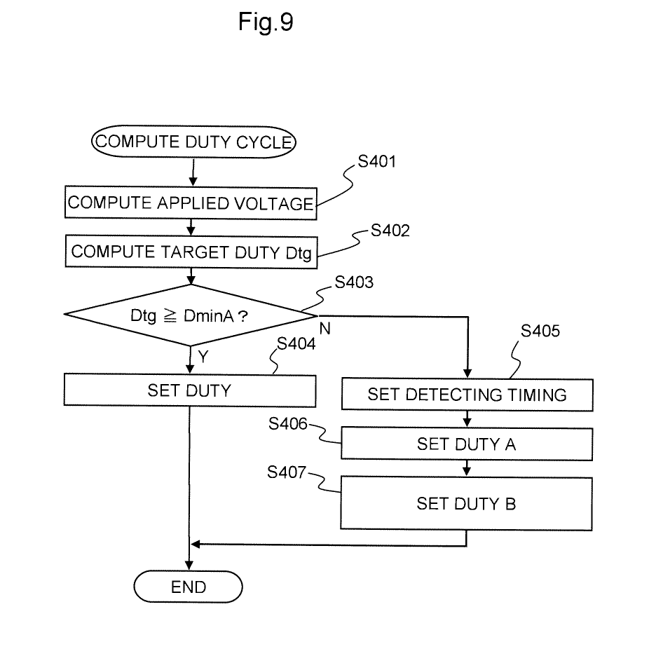

The decisions of the duty cycle in step S302 and step S312 are carried out with reference to a flowchart in FIG. 9.

In step S401, controller 213 decides an applied voltage based on a difference between actual motor rotation speed MS and target motor rotation speed MStg, and in the next step S402, a target duty cycle Dtg to obtain the decided applied voltage is computed.

Then, in step S403, controller 213 decides whether or not target duty cycle Dtg is equal to or greater than lower limit DminA.

Here, when target duty cycle Dtg is equal to or greater than lower limit DminA, the position information can be detected at each PWM period by providing a pulse width of target duty cycle Dtg for each PWM period, and accordingly, the operation proceeds to step S404, in which controller 213 sets target duty cycle Dtg as a duty cycle for each PWM period.

In contrast, when target duty cycle Dtg is less than lower limit DminA, the operation proceeds to step S405, in which controller 213 sets a detecting timing of the position information of the rotor according to the N value given at this time. For example, when N=2, controller 213 sets such that the detection of the position information of the rotor is carried out once in twice of the PWM periods.

Next, in step S406, controller 213 sets duty cycle A in the PWM period in which the position information of the rotor is detected to lower limit DminA, and furthermore, in step S407, controller 213 calculates duty cycle B (B≧0%) in the PWM period in which the position information of the rotor is not detected, according to detection frequency N and target duty cycle Dtg.

When N=2, for example, controller 213 sets duty cycle B in the PWM period in which the position information of the rotor is not detected, as B=2×Dtg−DminA, and furthermore, when N=3, since A+B+B=DminA+B+B=3×Dtg, controller 213 sets duty cycle B in two PWM periods in which the position information of the rotor is not detected, as B=(3×Dtg−DminA)/2.

Thus, in step S407, controller 213 calculates duty cycle B in the PWM period in which the position information of the rotor is not detected, as B=(N×Dtg−DminA)/(N−1).

In the calculation of B=(N×Dtg−DminA)/(N−1), when “N×Dtg−DminA” is equal to or less than 0, duty cycle B in the PWM period in which the position information of the rotor is not detected is set to 0%. Accordingly, minimum value Davmin of the average duty cycle becomes Davmin=DminA/N.

Here, as illustrated in FIG. 8, detection frequency N is given in advance for each motor rotation speed area, and achievable minimum value Davmin of the average duty cycle is decided according to each detection frequency N. However, depending on characteristics of brushless motor 2, average duty cycle Dav which is less than minimum value Davmin of average duty cycle may be required to obtain target motor rotation speed MStg, as illustrated in FIG. 8 by the dotted line.

In the characteristics (2) of brushless motor 2 illustrated in FIG. 8 by the dotted line, motor rotation speed MS which is less than threshold MS (1) and greater than threshold MS (2) cannot be achieved without decreasing average duty cycle Dav to be less than minimum value Davnim.

However, while it is necessary to maintain the duty cycle in the period in which the position detection is performed to be lower limit DminA, even if the duty cycle in the period in which the position detection is not performed is decreased to 0%, average duty cycle Dav is merely decreased to minimum value Davmin at lowest. Furthermore, if the detection frequency of the position information is excessively decreased, the detecting period of the position information may become too long, thereby causing a loss of synchronism.

Thus, in step S303 and thereafter, and in step S313 and thereafter, controller 213 executes a process for a case in which even when the average duty cycle is decreased to minimum value Davmin of the average duty cycle, motor rotation speed MS cannot be decreased to target rotation speed MStg.

In step S303, controller 213 decides whether or not cycle mode CM at that time is a cycle mode CM60, in which six different energization patterns EP1 to EP6 are switched over every electric angle of 60 degrees.

In the square wave drive according to the present embodiment, cycle mode CM60 is set as a standard cycle mode CM.

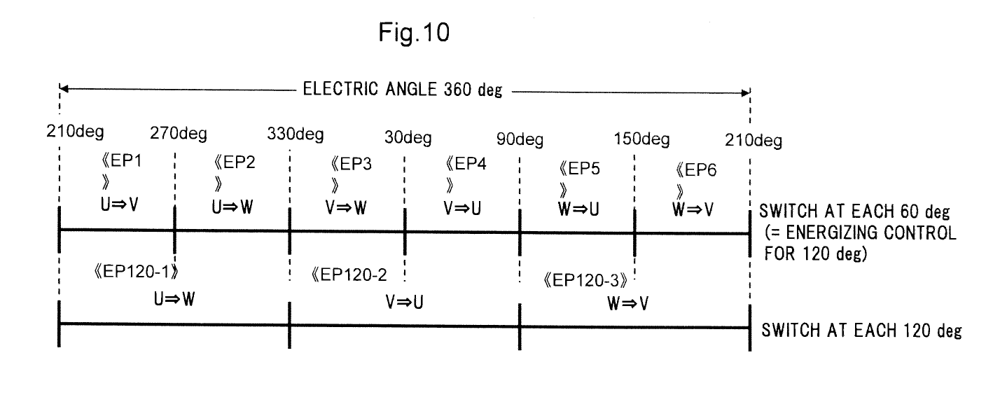

As illustrated in FIG. 10, in cycle mode CM60, by controller 213, electric current flows from the U-phase to the V-phase in energization pattern EP1, from the U-phase to the W-phase in energization pattern EP2, from the V-phase to the W-phase in energization pattern EP3, from the V-phase to the U-phase in energization pattern EP4, from the W-phase to the U-phase in energization pattern EP5, and from the W-phase to the V-phase in energization pattern EP6. Thus, controller 213 switches the energization patterns in the order of EP1, EP2, EP3, EP4, EP5, EP6, EP1, . . . , every electric angle of 60 degrees.

Here, when an angular position of a coil of U-phase is set as a reference position in which an angle of the rotor is 0 degree, an angular position of the rotor at which energization pattern EP3 is switched to energization pattern EP4 is set to 30 degrees, an angular position of the rotor at which energization pattern EP4 is switched to energization pattern EP5 is set to 90 degrees, an angular position of the rotor at which energization pattern EP5 is switched to energization pattern EP6 is set to 150 degrees, an angular position of the rotor at which energization pattern EP6 is switched to energization pattern EP1 is set to 210 degrees, an angular position of the rotor at which energization pattern EP1 is switched to energization pattern EP2 is set to 270 degrees, and an angular position of the rotor at which energization pattern EP2 is switched to energization pattern EP3 is set to 330 degrees.

Furthermore, as cycle mode CM, a cycle mode CM120, which has a greater electric angle of the switching period of the energization patterns than that of cycle mode CM60, is set.

As illustrated in FIG. 10, cycle mode CM120 is a cycle mode CM in which three energization patterns, that is, an energization pattern EP120-1 in which electric current flows from the U-phase to the W-phase, an energization pattern EP120-2 in which electric current flows from the V-phase to the U-phase, and an energization pattern EP120-3 in which electric current flows from the W-phase to the V-phase, are switched every electric angle of 120 degrees.

In cycle mode CM120, an angular position of the rotor at which energization pattern EP120-1 is switched to energization pattern EP120-2 is set to 330 degrees, which is the same as the angle at which energization pattern EP2 is switched to energization pattern EP3 in cycle mode CM60, an angular position of the rotor at which energization pattern EP120-2 is switched to energization pattern EP120-3 is set to 90 degrees, which is the same as the angle at which energization pattern EP4 is switched to energization pattern EP5 in cycle mode CM60, and an angular position of the rotor at which energization pattern EP120-3 is switched to energization pattern EP120-1 is set to 210 degrees, which is the same as the angle at which energization pattern EP6 is switched to energization pattern EP1 in cycle mode CM60.

Thus, in cycle mode CM60 and cycle mode CM120, the switch from the energization pattern in which electric current flows from the U-phase to the W-phase to the next energization pattern is performed at the angular position of 330 degrees, the switch from the energization pattern in which electric current flows from the V-phase to the U-phase to the next energization pattern is performed at the angular position of 90 degrees, and the switch from the energization pattern in which electric current flows from the W-phase to the V-phase to the next energization pattern is performed at the angular position of 210 degrees.

Then, controller 213 compares the pulse induced voltage of the non-energized phase with a threshold according to the energization pattern at that time, to detect a timing when the pulse induced voltage of the non-energized phase crosses the threshold as an angle at which the energization patterns are switched over.

When controller 213 decides in step S303 that phase energization is controlled according to the cycle mode CM60, the operation proceeds to step S304, in which it is decided whether a difference ΔMS between target motor rotation speed MStg and actual motor rotation speed MS (ΔMS=MStg−MS) is equal to or less than a negative predetermined value ΔMSSL (ΔMSSL<0) or not, that is, it is decided whether actual motor rotation speed MS is greater than target motor rotation speed MStg by the predetermined value or more or not.

Here, when ΔMS≧ΔMSSL, actual motor rotation speed MS can approach target motor rotation speed MStg even in cycle mode CM60, and accordingly, the switch from cycle mode CM60 to cycle mode CM120 is not required, so that controller 213 continues the energization control in cycle mode CM60 by terminating the routine.

In contrast, when ΔMS≦ΔMSSL, if the switch from cycle mode CM60 to cycle mode CM120 is not performed, actual motor rotation speed MS may not be decreased to target motor rotation speed MStg, and thus, the operation of controller 213 proceeds to step S305.

In step S305, controller 213 decides whether an absolute value ΔtMS of a difference between a latest detection value of an actual motor rotation speed MS and an actual motor rotation speed MS at the time of previous execution of this routine is equal to or less than a predetermined value ΔtMSSL (ΔtMSSL>0) or not, to decide whether actual motor rotation speed MS remains above target motor rotation speed MStg or not.

Here, when ΔtMS>ΔtMSSL, actual motor rotation speed MS is changing, and accordingly, may approach target motor rotation speed MStg thereafter. Thus, controller 213 continues the energization control in cycle mode CM60 by terminating the routine.

In contrast, when ΔtMS≦ΔtMSSL, actual motor rotation speed MS remains above target motor rotation speed MStg, and thus, the operation of controller 213 proceeds to step S306.

In step S306, controller 213 decides whether or not a state in which actual motor rotation speed MS remains above target motor rotation speed MStg continues for a predetermined period of time TSL or longer.

When the state in which actual motor rotation speed MS remains above target motor rotation speed MStg continues for predetermined period of time TSL or longer, controller 213 decides that even when average duty cycle Dav is decreased to minimum value Davmin of average duty cycle in the detection frequency at that time, actual motor rotation speed MS cannot be decreased to target motor rotation speed MStg, and then, the operation proceeds to step S307.

That is, each of the decision values ΔMSSL, ΔtMSSL and TSL in step S304, step S305 and step S306 is adjusted in advance, to decide whether or not actual motor rotation speed MS cannot be decreased to target motor rotation speed MStg even if average duty cycle Dav is decreased to minimum value Davmin.

In step S307, controller 213 switches from cycle mode CM60 in which energization patterns are switched every electric angle of 60 degrees, to cycle mode CM120 in which energization patterns are switched every electric angle of 120 degrees. Thus, when actual motor rotation speed MS cannot be decreased to target motor rotation speed MStg even when average duty cycle Dav is decreased to minimum value Davmin, controller 213 increases an electric angle, which is a switching period of the energization pattern.

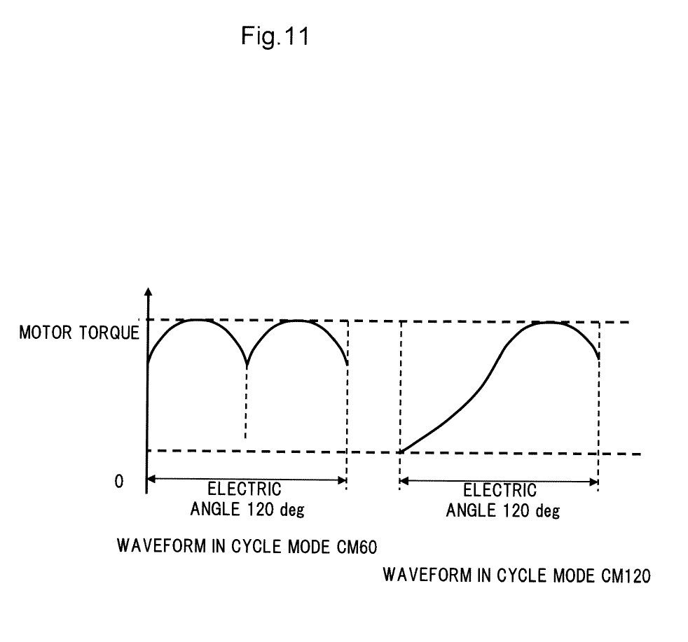

FIG. 11 illustrates a motor torque in cycle mode CM60 and a motor torque in cycle mode CM120, at the same average duty cycle Dav.

As illustrated in FIG. 11, even when an applied voltage is controlled at the same average duty cycle Dav, the motor torque in cycle mode CM120 is approximately ¾ of the motor torque in cycle mode CM60, and accordingly, when cycle mode CM60 is switched to cycle mode CM120, motor rotation speed MS decreases toward target motor rotation speed MStg due to the decrease in motor torque.

That is, when average duty cycle Dav is decreased to minimum value Davmin, average duty cycle Dav cannot be decreased further, so that motor rotation speed MS cannot be decreased from motor rotation speed MS at that time. However, if cycle mode CM60 is switched to cycle mode CM120, motor rotation speed MS can be decreased to near target motor rotation speed MStg.

In an example illustrated in FIG. 5, when target rotation speed MStg is MStg1, actual motor rotation speed MS can be decreased to target rotation speed MStg1 by decreasing average duty cycle Dav in cycle mode CM60.

In contrast, when target rotation speed MStg is MStg2, motor rotation speed MS is decreased to as far as rotation speed MSmin at the time average duty cycle Dav is set to minimum value Davmin, and thus, in control of average duty cycle Dav, motor rotation speed MS cannot be decreased to the lower target rotation speed MStg2.

Thus, when controller 213 cannot decrease motor rotation speed MS to target rotation speed MStg2 even when average duty cycle Dav is decreased to minimum value Davmin1, the current cycle mode 60 is switched to cycle mode 120, to thereby decrease the motor torque, so that rotation speed is decreased to target motor rotation speed MStg2, which is lower than rotation speed MSmin.

Thus, by switching cycle mode CM60 to cycle mode CM120, motor rotation speed MS can be further decreased, while maintaining a detecting period of position information and a detecting accuracy of position information.

After switching to cycle mode CM120 as mentioned above, controller 213 decides in step S303 that cycle mode CM at that time is cycle mode CM120 in which the energization patterns are switched every electric angle 120 degrees, and then the operation proceeds to step S308.

In step S308, controller 213 decides whether or not an absolute value of a control difference ΔMS is equal to or less than a predetermined value ΔMSSLa (ΔMSSLa>0). When |ΔMS|>predetermined value ΔMSSLa, that is, motor rotation speed MS does not approach near target motor rotation speed MStg, the switch of energization patterns in cycle mode CM120 continues, by terminating the routine.

In contrast, when |ΔMS|≦predetermined value ΔMSSLa, that is, motor rotation speed MS approaches near target motor rotation speed MStg, the operation proceeds to step S309, in which controller 213 decides whether or not a state in which |ΔMS|≦predetermined value ΔMSSLa continues for a set time TSLcon or more.

Then, when the state of |ΔMSC|≦predetermined value ΔMSSLa continues for set time TSLcon or more, actual motor rotation speed MS stably converges on target motor rotation speed MStg, and then, the operation of controller 213 proceeds to step S310. In contrast, when actual motor rotation speed MS does not stably converge on target motor rotation speed MStg, controller 213 continues switching the energization patterns in cycle mode CM120 by terminating the routine.

In step S310, controller 213 decides whether or not actual motor rotation speed MS can be converged on target rotation speed MStg when average duty cycle Dav is set to minimum value Dav min or more, even if cycle mode CM is switched back to cycle mode CM60.

To generate an equivalent torque when cycle mode CM120 is switched to cycle mode CM60, average duty cycle Dav in cycle mode CM60 needs to be decreased to ¾ of average duty cycle Dav in cycle mode CM120. Thus, if a value of ¾ of average duty cycle Dav in cycle mode CM120 is equal to or greater than minimum value Davmin, a torque equivalent to the motor torque in cycle mode CM120 can be obtained at the average duty cycle which is equal to or greater than minimum value Davmin, even if the cycle mode CM is switched back to cycle mode CM60.

When controller 213 decides in step S310 that cycle mode CM can be switched back to cycle mode CM60, the operation proceeds to step S311, in which cycle mode CM is switched from cycle mode CM120 to cycle mode CM60, to switch the electric angles, which are the switching periods of the energization patterns, from 120 degrees to 60 degrees.

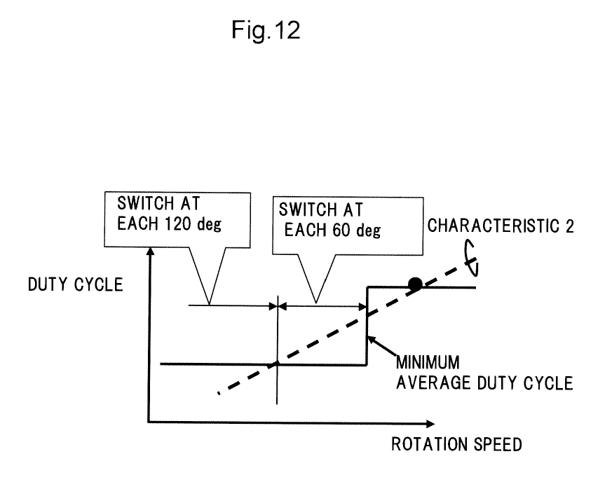

That is, as illustrated in FIG. 12, controller 213 selects cycle mode CM60 in a rotation speed area in which a required average duty cycle is equal to or greater than minimum value Davmin in cycle mode 60 in order to converge actual motor rotation speed MS on target motor rotation speed MStg. In contrast, controller 213 selects cycle mode CM120 in a rotation speed area in which the required average duty cycle is less than minimum value Davmin in cycle mode CM60 in order to converge actual motor rotation speed MS on target motor rotation speed MStg.

When controller 213 decides in step S301 that both target motor rotation speed MStg and actual motor rotation speed MS are less than set rotation speed MSSL, the operation proceeds to step S312, in which detection frequency N is set to N2 (N2>N1≧1), to decrease detection frequency from that in a case in which the operation proceeds to step S302, and thus, duty cycle for each PWM period is decided according to detection frequency N2.

By setting the N value in step S312 to be greater than detection frequency N in step S302, minimum value Davmin of average duty cycle in the rotation speed area lower than set rotation speed MSSL becomes a lower value compared to that in the rotation speed area higher than set rotation speed MSSL.

Next, in step S313, controller 213 decides whether or not cycle mode CM at that time is cycle mode CM120.

When cycle mode CM at that time is cycle mode CM120, the operation proceeds to step S314 and thereafter, in which controller 213 decides whether or not cycle mode CM can be switched back to cycle mode CM60 similarly to step S308 to step S310.

In step S314, controller 213 decides whether or not an absolute value of control difference ΔMS is equal to or less than predetermined value ΔMSSLa. When |ΔMS|>predetermined value ΔMSSLa, that is, motor rotation speed MS does not approach near target motor rotation speed MStg, the switch of energization patterns in cycle mode CM120 continues, by terminating the routine.

In contrast, when |ΔMS|≦predetermined value ΔMSSLa, that is, motor rotation speed MS approaches near target motor rotation speed MStg, the operation of proceeds to step S315, in which controller 213 decides whether or not a state in which |ΔMS|≦predetermined value ΔMSSLa continues for set time TSLcon or more.

Then, when the state of |ΔMS|≦predetermined value ΔMSSLa continues for set time TSLcon or more, and actual motor rotation speed MS stably converges on target motor rotation speed MStg, the operation of controller 213 proceeds to step S316. In contrast, when actual motor rotation speed MS does not stably converges on target motor rotation speed MStg, controller 213 continues switching the energization patterns in cycle mode CM120 by terminating the routine.

In step S316, controller 213 decides whether or not actual motor rotation speed MS can be converged on target rotation speed MStg when average duty cycle Dav is set to minimum value Davmin or more, even if the cycle mode CM is switched back to cycle mode CM60.

When controller 213 decides in step S316 that cycle mode CM can be switched back to cycle mode CM60, the operation proceeds to step S317, in which cycle mode CM is switched from cycle mode CM120 to cycle mode CM60, to switch the electric angles, which are the switching periods of the energization patterns, from 120 degrees to 60 degrees.

In the example illustrated in FIG. 5, controller 213 decreases the detection frequency of position information, when target rotation speed MStg is set to MStg2 to switch to cycle mode CM120 and then target motor rotation speed MStg is switched to MStg3. Then, when minimum value cycle Davmin of the average duty cycle is decreased to Davmin2 by decreasing the detection frequency, rotation speed MS can converges on target rotation speed MStg3 in the average duty cycle Dav, which is equal to or greater than minimum value cycle Davmin2 even when cycle mode CM is switched back to cycle mode CM60, and thus, controller 213 switches cycle mode CM back to cycle mode CM60.

In contrast, when controller 213 decides in step S313 that cycle mode CM is cycle mode CM60, the operation proceeds to step S318 and thereafter, in which a process of switching to cycle mode CM120 is executed, similarly to step S304 to step S307.

In step S318, controller 213 decides whether or not control difference ΔMS is equal to or less than the negative predetermined value ΔMSSL. Then, when ΔMS>ΔMSSL, the switch from cycle mode CM60 to cycle mode CM120 is not required, so that controller 213 continues the energization control in cycle mode CM60 by terminating the routine.

In contrast, when ΔMS≦ΔMSSL, the operation of controller 213 proceeds to step S319, in which controller 213 decides whether or not an absolute value ΔtMS of a difference between a latest value and a previous value of actual motor rotation speed MS is equal to or less than predetermined value ΔtMSSL, to decide whether or not actual motor rotation speed MS remains above target motor rotation speed MStg.

Here, when ΔtMS>ΔtMSSL, actual motor rotation speed MS is changing, and accordingly, may approach target motor rotation speed MStg thereafter. Thus, controller 213 continues the energization control in cycle mode CM60 by terminating the routine.

In contrast, when ΔtMS≦ΔtMSSL, actual motor rotation speed MS remains above target motor rotation speed MStg, and thus, the operation of controller 213 proceeds to step S320.

In step S320, controller 213 decides whether or not a state in which actual motor rotation speed MS remains above target motor rotation speed MStg continues for predetermined period of time TSL or longer.

When the state in which actual motor rotation speed MS remains above target motor rotation speed MStg continues for predetermined period of time TSL or longer, controller 213 decides that even when average duty cycle Dav is decreased to minimum value Davmin in the detection frequency at that time, actual motor rotation speed MS cannot be decreased to target motor rotation speed MStg, and then, the operation proceeds to step S321.

In step S321, controller 213 switches cycle mode CM from cycle mode CM60 in which energization patterns are switched every electric angle of 60 degrees to cycle mode CM120 in which energization patterns are switched every electric angle of 120 degrees.

As mentioned above, in the above embodiment, when motor rotation speed MS cannot be decreased to target rotation speed MStg even when minimum value Davmin of the average duty cycle is decreased by decreasing the detection frequency of the position information of the rotor, cycle mode CM is switched from cycle mode CM60 to cycle mode CM120, to decrease the motor torque, so that motor rotation speed MS can be decreased to target rotation speed MStg.

Thus, the rotation speed of brushless motor 2 can be controlled to the low rotation speed, which cannot be achieved by merely decreasing the detection frequency of the position information of the rotor, and accordingly, a control range of the rotation speed of brushless motor 2 can be expanded on a lower rotation speed side.

Therefore, in a case of brushless motor 2 which drives electric oil pump 1, a minimum discharge amount of electric oil pump 1 can be decreased, an unnecessarily increase in power consumption of brushless motor 2 due to the unnecessary discharge amount can be suppressed, and the rotation speed of electric oil pump 1 can be immediately decreased, and accordingly, reduction in noise of the pump, and the like, can be achieved.

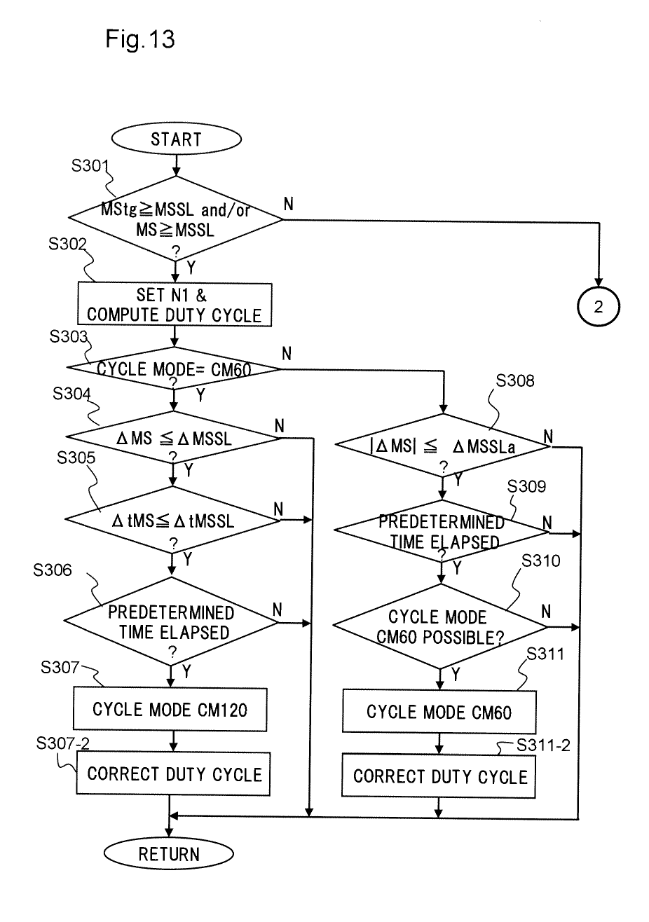

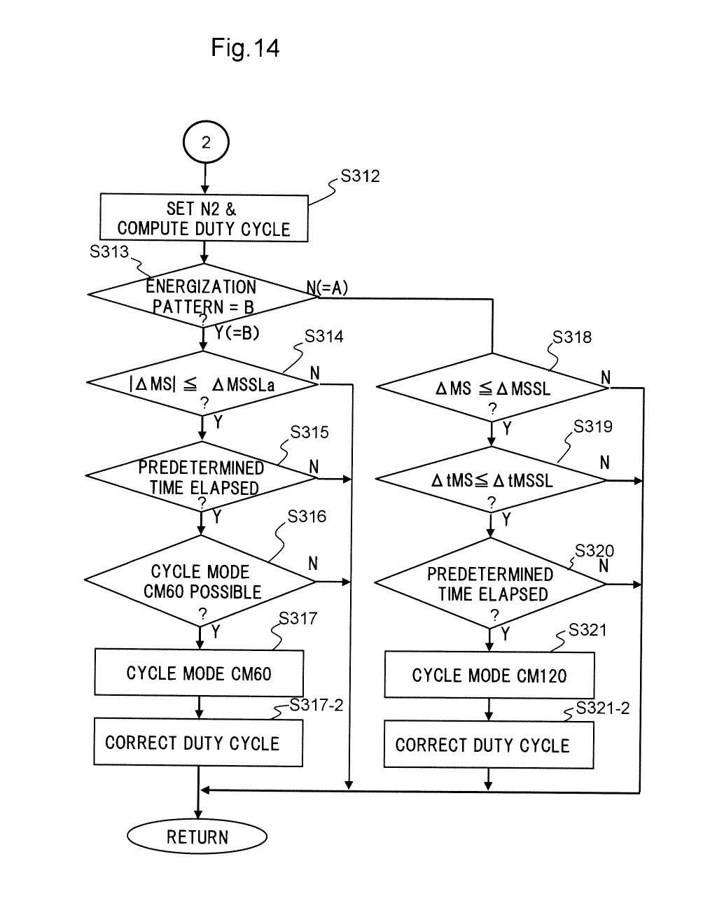

In a case in which cycle mode CM is switched between cycle mode CM60 and cycle mode CM120, when power is supplied at the same average duty cycle Dav, a torque variation may increase due to an increase or decrease in the motor torque, as mentioned above. The torque variation caused by the switch of cycle modes CM can be decreased by changing the duty cycle. A motor control in which the changing process of the duty cycle is added will be described with reference to flowcharts of FIGS. 13 and 14.

A routine illustrated in the flowcharts of FIGS. 13 and 14 is different from that in the flowcharts of FIGS. 3 and 4 in that, there is added, after the step of switching cycle modes CM, a process of setting an initial value of a duty cycle in a changed cycle mode CM based on a duty cycle immediately before the switch of cycle modes CM. The step of switching cycle modes CM is executed similarly to that in the flowcharts of FIGS. 3 and 4.

Thus, in the flowcharts of FIGS. 13 and 14, the same reference number is given to a step which includes the same processing content as that in the flowcharts of FIGS. 3 and 4, and detailed explanation thereof is omitted. Hereunder, a process of changing a duty cycle associated with the switch of cycle modes CM will be described.

In the flowcharts of FIGS. 13 and 14, in step S307 or step S321, controller 213 sets to switch from cycle mode CM60 to cycle mode CM120, and then the operation proceeds from step S307 to step S307-2, or from step S321 to step S321-2, in which a duty cycle after changing cycle mode is set.

In a case in which cycle mode CM60 is switched to cycle mode CM120, since a motor torque decreases when the duty cycle is constant, if the duty cycle is increased, the decrease in the motor torque can be suppressed, so that the variation of the motor torque associated with the switch of cycle modes CM can be suppressed.

Here, in a case in which the motor torque decreases to ¾ (75%) thereof when cycle mode CM60 is switched to cycle mode CM120 while the duty cycle is constant, and in which the motor torque is proportional to the duty cycle, if the duty cycle after changing cycle mode CM is corrected to be increased to 4/3 times of the duty cycle before changing cycle mode CM together with switching from cycle mode CM60 to cycle mode CM120, motor torques before and after switching cycle modes CM can be substantially the same, and thus, the variation of the motor torque associated with the switch of cycle modes CM can be suppressed.

In a case in which the duty cycle is computed by a PID control based on a difference between actual motor rotation speed MS and target motor rotation speed MStg, for example, when cycle modes CM are switched, controller 213 changes the duty cycle so that the variation of motor torque associated with the switch of cycle modes can be suppressed, by controlling an integrated portion without changing a proportionated portion or differentiated portion before and after switching.

Thus, the variation of motor torque associated with the switch of cycle modes CM can be suppressed, without reducing a responsiveness of the convergence on the target rotation speed after switching cycle modes CM.

Furthermore, in the flowcharts of FIGS. 13 and 14, in step S311 or step S317, controller 213 sets to switch from cycle mode CM120 to cycle mode CM60, and then the operation proceeds from step S311 to step S311-2, or from step S317 to step S317-2, in which the duty cycle after changing cycle mode CM is set.

In a case in which cycle mode CM120 is switched to cycle mode CM60, since a motor torque increases when the duty cycle is constant, if the duty cycle is decreased, the increase in the motor torque can be suppressed, so that the variation of the motor torque associated with the switch of cycle modes CM can be suppressed.

Here, in a case in which the motor torque increases by 25% when cycle mode CM120 is switched to cycle mode CM60 while the duty cycle is constant, and in which the motor torque is proportional to the duty cycle, if the duty cycle after changing cycle mode is corrected to be decreased to ¾ of the duty cycle before changing cycle mode, together with switching from cycle mode CM120 to cycle mode CM60, the motor torques before and after switching cycle modes CM can be substantially the same, and thus, the variation of the motor torque associated with the switch of cycle modes CM can be suppressed.

If the variation of the motor torque associated with the switch of cycle modes CM can be suppressed as mentioned above, temporarily large variation of the motor torque associated with the change in motor rotation speed can be suppressed, and thus, a following performance with respect to the target rotation speed can be improved.

Furthermore, in brushless motor 2 which drives electric oil pump 1, a sudden change in discharge amount can be suppressed, so that the oil pressure can be stably controlled.

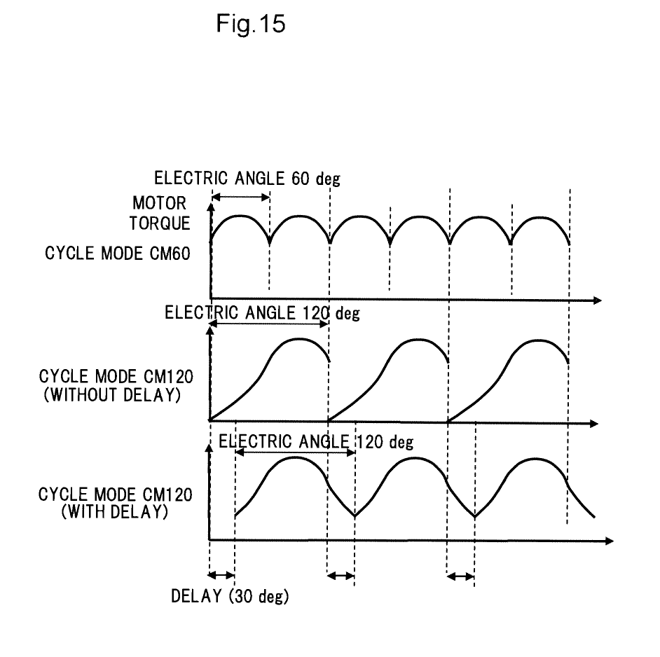

Still further, the square wave drive in which the energization patterns, which are the selection patterns of two phases selected from the three phases, to which two phases the pulse voltage is applied, are sequentially switched according to the predetermined switching timing, tends to increase the torque variation compared to the sine wave drive. In addition, when cycle mode CM is switched from cycle mode CM60 to cycle mode CM120 in the square wave drive, a difference between motor torques before and after the switch of cycle modes CM may be increased, so that the torque variation may be increased, as illustrated in FIG. 15.

Here, as illustrated in FIG. 15, by delaying a switching timing of the energization pattern in cycle mode CM120 from a timing synchronized with the switching timing in cycle mode CM60, the torque variation in cycle mode CM120 can be suppressed.

In an example illustrated in FIG. 15, a switch of energization patterns in cycle mode CM120 is carried out in a timing which is delayed from the switching timing of energization patterns in cycle mode CM60 by 30 degrees, so that a difference in torque between those before and after switching energization patterns, and a difference between a maximum value and a minimum value of the torque in cycle mode CM120 can be decreased, and accordingly, the torque variation in cycle mode CM120 can be decreased.

An angle by which the switch of energization patterns in cycle mode 120 is delayed is not limited to 30 degrees. The angle may appropriately set to an angle that sufficiently suppresses the torque variation. Furthermore, the angle by which the switch of energization patterns in cycle mode 120 is delayed can be changed according to the motor rotation speed, so that a change in a degree of torque variation according to the change in the motor rotation speed can be suppressed.

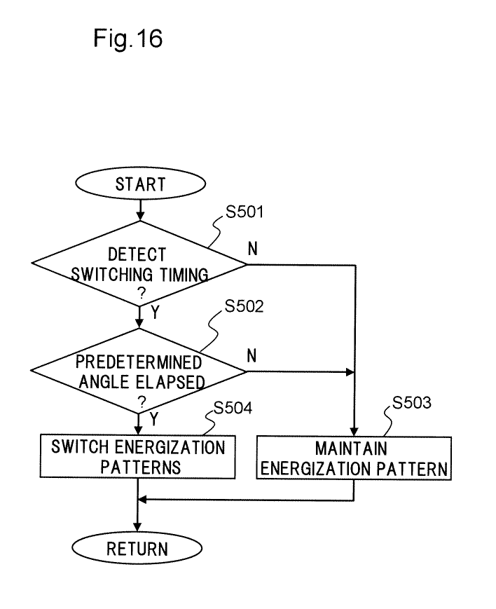

A flowchart in FIG. 16 illustrates an example of control in which the switch of energization patterns is carried out by delaying the switching timing in cycle mode CM120.

In the flowchart of FIG. 16, in step S501, controller 213 decides whether or not a basic switching timing from an energization pattern at that time to a next energization pattern is detected from basic switching timings which synchronize with a switching timing of energization patterns in cycle mode CM60 based on a comparison between the pulse induced voltage in the non-energized phase and the threshold.

When controller 213 decides in step S501 that the basic switching timing to the next energization pattern is not detected, the operation proceeds to step S503, in which the energization pattern at that time continues.

In contrast, when controller 213 decides in step S501 that the basic switching timing to the next energization pattern is detected, the operation proceeds to step S502, in which controller 213 decides whether or not a rotation is carried out by a predetermined angle after detecting the basic switching timing to the next energization pattern.

For example, controller 213 detects an angular position rotated by a predetermined angle from the basic switching timing as a timing in which a time required to rotate by the predetermined angle has elapsed from the time point in which the basic switching timing is detected by calculating the predetermined angle in terms of time based on the motor rotation speed at that time.

When controller 213 decides in step S502 that the rotated angle which is rotated from when the basic switching timing of the next energization pattern is detected does not reach the predetermined angle, the operation proceeds to step S503, in which the energization pattern at that time continues.

In contrast, when controller 213 decides in step S502 that the rotated angle rotated from when the basic switching timing of the next energization pattern is detected reaches the predetermined angle, the operation proceeds to step S504, in which the energization pattern is switched to the next energization pattern.

Thus, when the torque variation in cycle mode CM120 can be suppressed by delaying the switching timing of the energization patterns in cycle mode CM120, the discharge amount from electric oil pump 1 can be stabilized, and thus, the variation in the oil pressure can be suppressed.

In the motor drive control illustrated in the above-mentioned flowcharts of FIGS. 3 and 4, the example in which the N value (the detection frequency of the position information) is switched between two values, and in response to this, minimum value Davmin of the average duty cycle is switched in two steps. However, the N value may be switched among three or more values according to the change in motor rotation speed, and in response to this, minimum value Davmin may be switched in three or more steps.

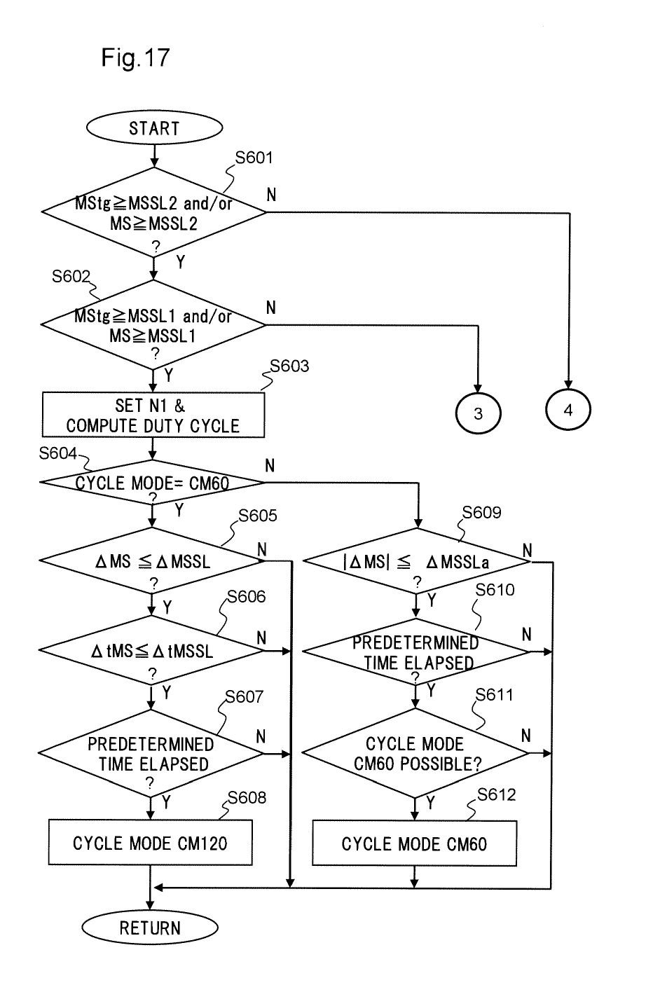

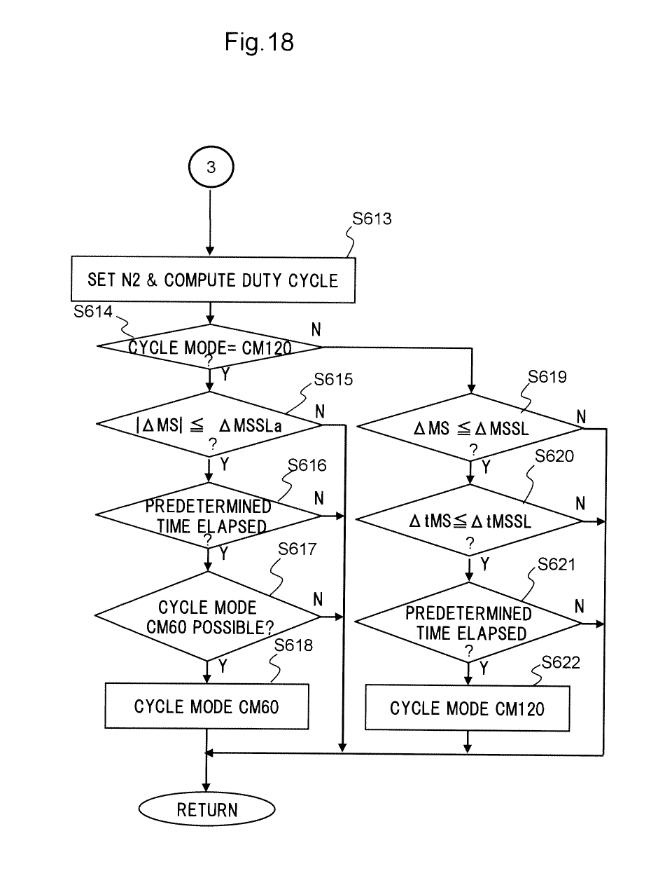

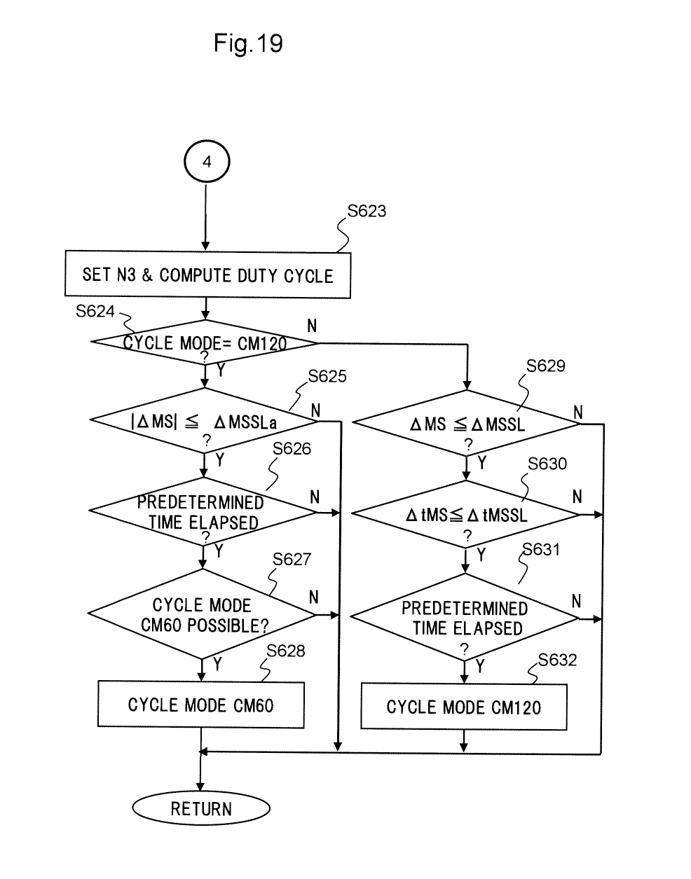

Flowcharts in FIGS. 17, 18 and 19 illustrate an example of the motor drive control in which the N value is switched among three values according to the change in motor rotation speed MS, and a setting of a switch between cycle modes CM60 and CM120 is executed.

In step S601, controller 213 decides whether or not at least one of target motor rotation speed MStg and actual motor rotation speed MS is equal to or greater than a set rotation speed MSSL2.

Then, when at least one of target motor rotation speed MStg and actual motor rotation speed MS is equal to or greater than set rotation speed MSSL2, the operation proceeds to step S602, in which controller 213 decides whether or not at least one of target motor rotation speed MStg and actual motor rotation speed MS is equal to or greater than a set rotation speed MSSL1 (MSSL1>MSSL2).

Here, when at least one of target motor rotation speed MStg and actual motor rotation speed MS is equal to or greater than set rotation speed MSSL1, the operation of controller 213 proceeds to step S603.

In step S603, controller 213 sets detection frequency N to N1 (N1≧1), to decide a duty cycle for each PWM period according to the detection frequency N1.

Next, the operation of controller 213 proceeds to step S604 and thereafter, in which the setting of cycle modes CM60 and CM120 is executed. Since the processing content in each of steps S604 to S612 is the same as that in steps S303 to S311 of the flowchart in FIG. 3, the detailed explanation is omitted.

In general, in a state in which energizing control is executed in cycle mode CM60, when motor rotation speed MS cannot be decreased to target rotation speed MStg, cycle mode MS60 is switched to cycle mode CM120, or in a state in which motor rotation speed MS converges on target motor rotation speed MStg and a motor torque equivalent to that in cycle mode 120 can be generated in the average duty cycle Dav of minimum value Davmin or above, even when cycle mode CM is switched back to cycle mode 60, cycle mode CM120 is switched to cycle mode CM60.

In contrast, when controller 213 decides in step S602 that target motor rotation speed MStg and actual motor rotation speed MS are less than set rotation speed MSSL1, that is, are equal to or greater than set rotation speed MSSL2 and less than set rotation speed MSSL1, the operation proceeds to step S613.

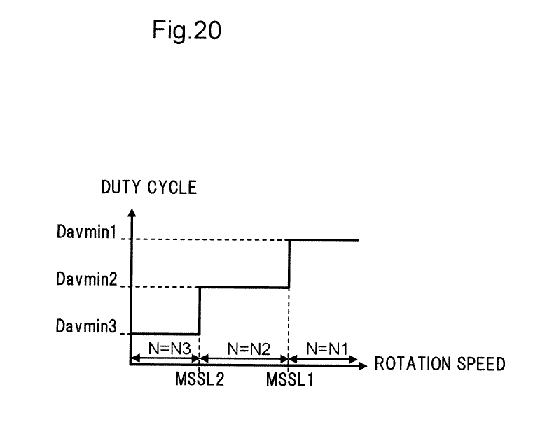

In step S613, controller 213 sets detection frequency N to N2 (N2>N1≧1), to decrease the detection frequency compared to that in step S603, to decide the duty cycle for each PWM period according to the detection frequency N2. Here, since the N value is set to be greater than that in step S603, minimum value Davmin is decreased, as illustrated in FIG. 20.

Next, the operation of controller 213 proceeds to step S614 and thereafter, in which the setting of cycle modes CM60 and CM120 is executed. Since the processing content in each of steps S614 to S622 is the same as that in steps S313 to S321 of the flowchart in FIG. 4, the detailed explanation is omitted.

In general, in a case in which motor rotation speed MS converges on target motor rotation speed MStg in cycle mode CM120 and the motor torque which is equivalent to that in cycle mode 120 can be generated in the average duty cycle Dav of minimum value Davmin or above even when cycle mode CM is switched back to cycle mode 60, cycle mode CM120 is switched to cycle mode CM60, and then, when motor rotation speed MS cannot decrease toward target motor rotation speed Mtg in a state in which the energizing control is executed in cycle mode CM60, cycle mode CM is switched to cycle mode CM120.

Furthermore, when controller 213 decides in step S601 that target motor rotation speed MStg and actual motor rotation speed MS are less than set rotation speed MSSL2, the operation proceeds to step S623.

In step S623, controller 213 sets detection frequency N to N3 (N3>N2>N1≧1), to further decrease the detection frequency compared to that in step S613, to decide the duty cycle for each PWM period according to the detection frequency N3. Here, since the N value is set to be greater than that in step S613, minimum value Davmin is further decreased, as illustrated in FIG. 20.

Next, the operation of controller 213 proceeds to step S624 and thereafter, in which the setting of cycle modes CM60 and CM120 is executed. Since the processing content in each of steps S624 to S632 is the same as that in steps S313 to S321 of the flowchart in FIG. 4, the detailed explanation is omitted.

In general, in a case in which motor rotation speed MS converges on target motor rotation speed MStg in cycle mode CM120 and the motor torque which is equivalent to that in cycle mode 120 can be generated in the average duty cycle Dav of minimum value Davmin or above even when cycle mode CM is switched back to cycle mode 60, cycle mode CM120 is switched to cycle mode CM60, and then, when motor rotation speed MS cannot decrease toward target motor rotation speed Mtg in a state in which the energizing control is executed in cycle mode CM60, cycle mode CM is switched to cycle mode CM120.

When the N value is switched among three or more values according to the change in the motor rotation speed, the duty cycle after switching cycle modes CM can be changed to suppress the variation of the motor torque, and in addition, a delaying process of the switching timing of the energization patterns in cycle mode CM120 can be executed, as illustrated in the flowcharts of FIGS. 13 and 14.

Since the torque variation in cycle mode CM120 is large compared to that in cycle mode CM60 and the variation of motor rotation speed tends to become large, the variation of motor rotation speed can be suppressed by executing the energizing control in cycle mode CM60, i.e., not in cycle mode CM120, when the variation of motor rotation speed exceeds the set level.

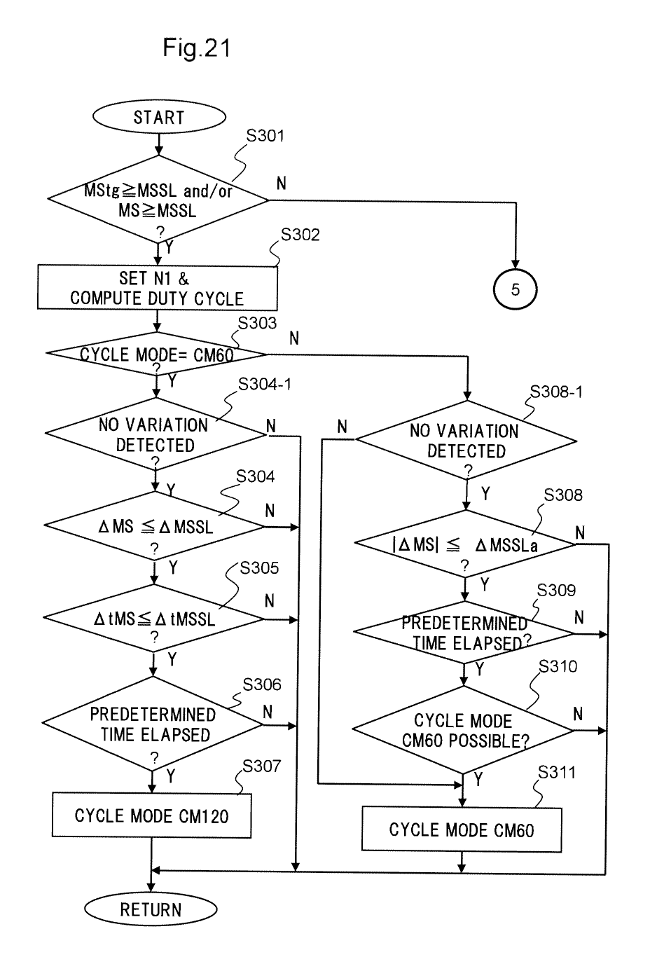

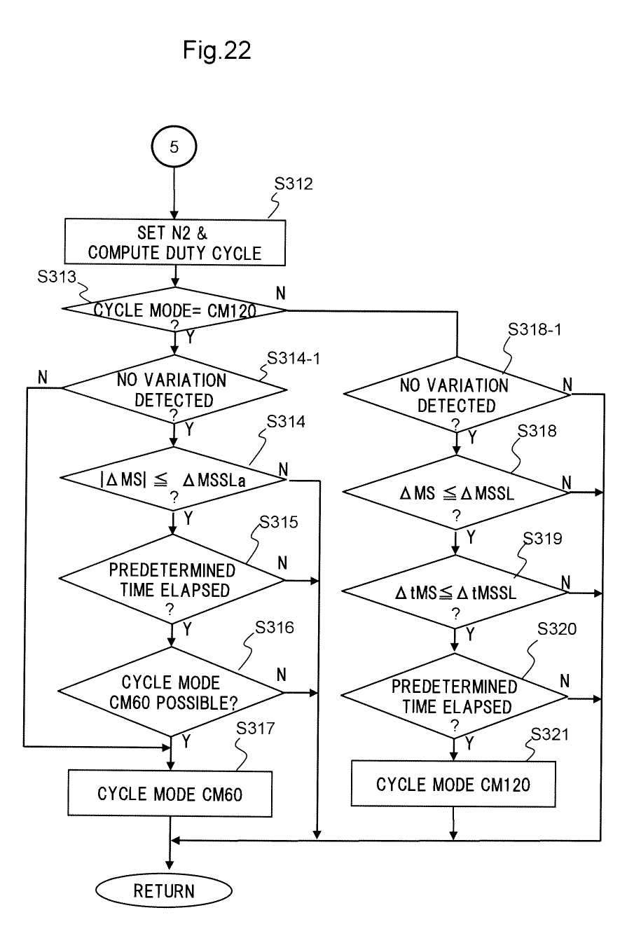

Flowcharts of FIGS. 21 and 22 illustrate an example of the motor control, in which it is decided whether or not the energizing control is executed in cycle mode CM120 according to the variation of motor rotation speed.

A routine illustrated in the flowcharts of FIGS. 21 and 22 is a routine in which a step of deciding whether or not the variation of motor rotation speed exceeds the set level is added to the routine of the flowcharts in FIGS. 3 and 4. Since the other steps include the same processing contents as those in the routine illustrated in the flowcharts of FIGS. 3 and 4, the same reference number is given to a step which executes the same processing as that in the routine illustrated in the flowcharts of FIGS. 3 and 4, and detailed explanation thereof is omitted.

In the flowcharts of FIGS. 21 and 22, controller 213 decides in step S301 that at least one of target motor rotation speed MStg and actual motor rotation speed MS is equal to or greater than set rotation speed MSSL, and then, the operation proceeds to step S303. Then, when it is decided that cycle mode CM60 is selected as cycle mode CM, it is decided in step S304-1 whether or not the variation of motor rotation speed is detected.

The detection of the variation of motor rotation speed will be described in detail, hereinbelow.

Then, when the variation of motor rotation speed is sufficiently small, the operation of controller 213 proceeds to step S304 and thereafter, in which the switch to cycle mode CM120 is carried out when the motor rotation speed cannot be decreased toward the target.

In contrast, when the variation of motor rotation speed in a state in which the energizing control is executed in cycle mode CM120 exceeds the set level, controller 213 continues the drive control in cycle mode CM60 by terminating the routine in order to suppress a further increase in the variation of motor rotation speed which will be caused by switching to cycle mode CM120, even when the motor rotation speed cannot be decreased toward the target.

Furthermore, when controller 213 decides in step S303 that cycle mode CM120 is selected as cycle mode CM, the operation proceeds to step S308-1, in which it is decided whether or not the variation of motor rotation speed is detected.

When the variation of motor rotation speed is detected, the operation proceeds to step S311 without deciding whether or not the motor rotation speed converged on the target, in which step S311 cycle mode CM is switched back to cycle mode CM60, to reduce the variation of motor rotation speed.

Furthermore, when cycle mode CM120 is selected and the variation of motor rotation speed is not detected, the operation of controller 213 proceeds to step S308 and thereafter, in which when the motor rotation speed converges on the target and it is decided that the equivalent motor torque can be generated even when cycle mode CM is switched back to cycle mode CM60, the process of switching back to cycle mode CM60 is executed.

The selection of the cycle mode based on the variation of motor rotation speed is similarly performed in a case in which it is decided in step S301 that target motor rotation speed MStg and actual motor rotation speed MS are less than set rotation speed MSSL.

Controller 213 decides that target motor rotation speed MStg and actual motor rotation speed MS are less than set rotation speed MSSL, and then, the operation proceeds to step S313. When it is decided that cycle mode CM120 is selected, the operation proceeds to step S314-1, in which it is decided whether or not the variation of motor rotation speed is detected.

When the variation of motor rotation speed is detected, the operation of controller 213 proceeds to step S317 without deciding whether or not the motor rotation speed converges on the target, in which step S317 cycle mode CM is switched back to cycle mode CM60, to reduce the variation of motor rotation speed.

Furthermore, when cycle mode CM120 is selected and the variation of motor rotation speed is not detected, the operation of controller 213 proceeds to step S314 and thereafter, in which cycle mode CM is switched back to cycle mode CM60 when the motor rotation speed converges on the target and the equivalent motor torque can be generated even when cycle mode CM is switched back to cycle mode CM60.

In contrast, when controller 213 decides in step S313 that cycle mode CM60 is selected, the operation proceeds to step S318-2, in which it is decided whether or not the variation of motor rotation speed is detected.

Then, when the variation of motor rotation speed is not detected, the operation of controller 213 proceeds to step S318 and thereafter, in which cycle mode CM is switched to cycle mode CM120 when the motor rotation speed cannot be decreased toward the target.

In contrast, when the variation of motor rotation speed in a state in which the energizing control is executed in cycle mode CM60 exceeds the set level, controller 213 continues the drive control in cycle mode CM60 by terminating the routine in order to suppress a further increase in variation of motor rotation speed which will be caused by switching to cycle mode CM120, even when the motor rotation speed cannot be decreased toward the target.

According to the above control, an excessive rotation variation can be suppressed by selecting cycle mode CM120.

The setting of cycle mode CM based on the variation of motor rotation speed as mentioned above can be applied to a case in which the N value is switched among three or more values according to the change in motor rotation speed, and furthermore, the process of changing the duty cycle after switching cycle modes CM in order to suppress the variation of motor torque and/or the process of delaying the switching timing of the energization pattern in cycle mode CM120 may be combined with the setting of cycle mode CM based on the variation of motor rotation speed.

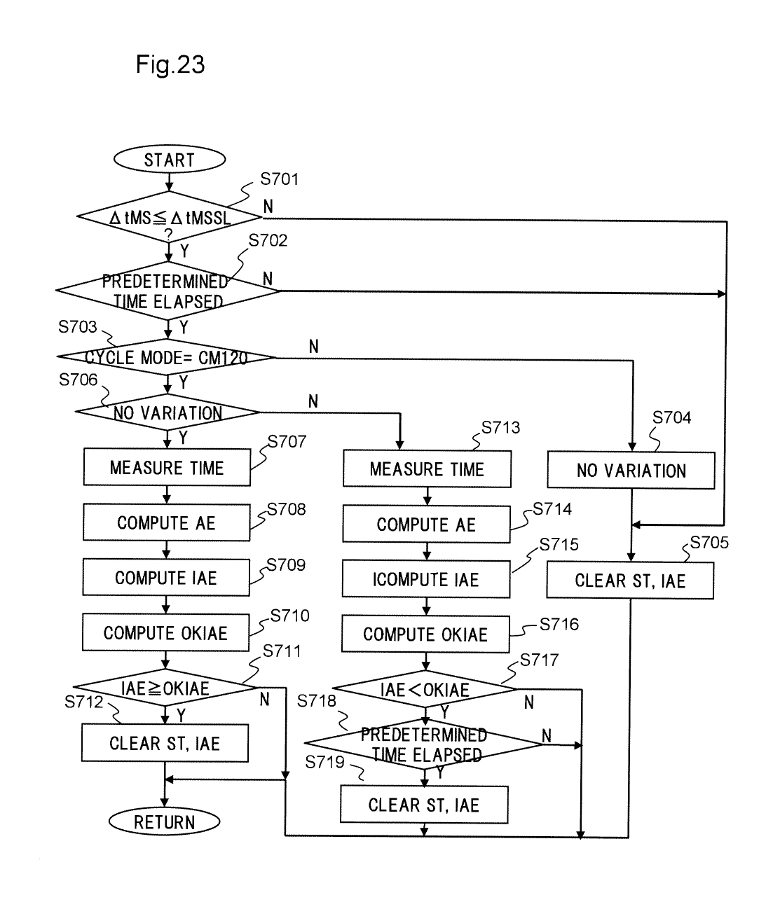

A flowchart in FIG. 23 illustrates the variation detection of motor rotation speed in detail.

In step S701, controller 213 decides whether or not an absolute value of a difference between a previous value and a latest value of target rotation speed MStg is equal to or less than a set value, that is, whether or not target rotation speed MStg does not vary for a predetermined time.

Then, when the varied amount of target rotation speed MStg per unit time is equal to or less than the set value, the operation proceeds to step S702, in which controller 213 decides whether or not the state in which the varied amount of target rotation speed MStg per unit time is equal to or less than the set value continues for the set time period or more, to decide whether or not it is in a stable state in which target rotation speed MStg is maintained to be a constant value.

When controller 213 decides in step S701 that the varied amount of target rotation speed MStg per unit time is greater than the set value, or decides in step S702 that the duration time does not reach the set time period, that is, target rotation speed MStg is not in the stable state, the operation proceeds to step S705, in which variables ST, IAE used in the detection of rotation variation are cleared, and then the routine is ended.

In contrast, when controller 213 decides in step S701 that the varied amount of target rotation speed MStg per unit time is equal to or less than the set value, and decides in step S702 that the duration time exceeds the set time period, and in addition, when target rotation speed MStg is in the stable state, the operation proceeds to step S703.

In step S703, controller 213 decides whether cycle mode CM selected at that time is cycle mode CM60 or cycle mode CM120.

Then, when the energization patterns are switched according to cycle mode CM60, the operation proceeds to step S704, in which controller 213 decides that there is no variation of motor rotation speed, and then the variables used in the detection of rotation variation are cleared in step S705, followed by terminating the routine.

When the energization patterns are switched according to cycle mode CM60, the variation of motor rotation speed may not excessively increase. However, when the energization patterns are switched according to cycle mode CM120, the variation of motor rotation speed may excessively increase. Thus, in cycle mode CM60, controller 213 decides that there is no rotation variation, without detecting an actual rotation variation.

Thus, in the flowcharts of FIGS. 21 and 22, step S304-1 and step S318-1 may be omitted. Alternatively, even in cycle mode CM60, controller 213 may detect the actual rotation variation, to detect an occurrence of the rotation variation in step S304-1 and step S318-1.

When controller 213 decides in step S703 that cycle mode CM120 is selected, the operation proceeds to step S706, in which controller 213 decides whether or not the previous decision result indicates that the variation of motor rotation speed has occurred.

When the previous decision result indicates that no variation of motor rotation speed has occurred, the operation proceeds to step S707, in which controller 213 measures an elapsed time ST after target rotation speed MStg is stabilized.

Next, controller 213 computes in step S708 an absolute value AE of a difference between a previous value and a latest value of a motor rotation angle, that is, absolute value AE of an amount of angular change per unit time (AE=|(latest angle)−(previous angle)|).

Furthermore, in step S709, controller 213 adds absolute value AE of the amount of angular change to integrated value IAE obtained by combining values up to the previous value, to update integrated value IAE (IAE=IAEold+AE).

In step S710, controller 213 calculates an allowable value OKIAE of angular change integrated value IAE based on elapsed time ST.

Controller 213 may obtain allowable value OKIAE with reference to a table in which allowable values OKIAE are stored every elapsed time ST, or alternatively, controller 213 may calculate allowable value OKIAE based on a function f(ST), wherein elapsed time ST is a variable, allowable value OKIAE being set to a greater value as elapsed time ST increases.

In the next step S711, controller 213 compares integrated value IAE with allowable value OKIAE, and then, when IAE<OKIAE, it is decided that there is no variation of motor rotation speed, so that the decision result indicating that there is no rotation variation is maintained by terminating the routine.

In contrast, when controller 213 decides in step S711 that IAE≧OKIAE, the operation proceeds to step S712, in which the decision result is switched to a decision result indicating that the rotation variation which exceeds the allowable level has occurred, and then elapsed time ST, integrated value IAE are cleared.

Furthermore, when the previous decision result indicates that variation in motor rotation speed has occurred, the operation of controller 213 proceeds from step S706 to step S713.

In step S713, controller 213 measures elapsed time ST after target rotation speed MStg is stabilized.

Next, in step S714, controller 213 computes absolute value AE of the difference between the previous value and the latest value of the motor rotation angle (AE=|(latest angle)−(previous angle)|).

Furthermore, in step S715, controller 213 adds absolute value AE of the amount of angular change to integrated value IAE obtained by combining values up to the previous value, to update integrated value IAE (IAE=IAEold+AE).

In step S716, controller 213 calculates allowable value OKIAE of integrated value IAE based on elapsed time ST.

Then, in step S717, controller 213 compares integrated value IAE with allowable value OKIAE, and then, when IAE<OKIAE and the variation of motor rotation speed has occurred, the decision result indicating that the rotation variation has occurred is maintained by terminating the routine.

In contrast, when controller 213 decides in step S717 that IAE<OKIAE, the operation proceeds to step S718, in which controller 213 decides whether or not a duration time of a state in which IAE<OKIAE exceeds a set time.

Here, when the duration time of the state in which IAE<OKIAE is less than the set time, controller 213 maintains the decision result indicating that the rotation variation has occurred by terminating the routine. When the duration of the state in which IAE<OKIAE is in exceeds the set time, the operation proceeds to step S719, in which the decision result is switched to the decision result indicating that there is no variation, and then elapsed time ST, integrated value IAE are cleared.

The method of detecting the occurrence of the variation of motor rotation speed is not limited to that illustrated in the flowchart of FIG. 23, and the occurrence of rotation variation may be detected based on a magnitude of an amplitude of the motor rotation speed, for example.

The contents of the present invention are described above in detail with reference to the preferred embodiment. However, it should be apparent that various modifications to the embodiments can be made by one skilled in the art based on the basic technical concepts and the teachings of the present invention described herein.

The entire contents of Japanese Patent Application No. 2013-007085, filed on Jan. 18, 2013, on which priority is claimed, are incorporated herein by reference.

While only select embodiments have been chosen to illustrate and describe the present invention, it will be apparent to those skilled in the art from this disclosure that various changes and modifications can be made herein without departing from the scope of the invention as defined in the appended claims.

Furthermore, the foregoing description of the embodiments according to the present invention is provided for illustrative purposes only, and it is not for the purpose of limiting the invention, the invention as claimed in the appended claims and their equivalents.

What is claimed is:

1. A drive apparatus for a brushless motor, comprising:
a driving unit that switches two phases according to position information based on a pulse induced voltage induced in a non-energized phase, the two phases being selected from three phases of the brushless motor and to be applied with a pulse voltage according to a pulse width modulation signal; and
a period changing unit that changes an electric angle of a switching period of phases to which the pulse voltage is applied, according to a rotation speed of the brushless motor.

2. The drive apparatus for the brushless motor according to claim 1, wherein the period changing unit increases the electric angle of the switching period when a duty cycle of the pulse width modulation signal decreases to a set value.

3. The drive apparatus for the brushless motor according to claim 1, further comprising:
a duty cycle changing unit that changes a duty cycle of the pulse width modulation signal when the electric angle of the switching period is changed.

4. The drive apparatus for the brushless motor according to claim 1, wherein the period changing unit switches the electric angles of the switching period between 60 degrees and 120 degrees according to the rotation speed of the brushless motor.

5. The drive apparatus for the brushless motor according to claim 4, further comprising:
a duty cycle changing unit that increases a duty cycle when the electric angle of the switching period is switched from an electric angle of 60 degrees to an electric angle of 120 degrees, and that decreases the duty cycle when the electric angle of the switching period is switched from the electric angle of 120 degrees to the electric angle of 60 degrees.

6. The drive apparatus for the brushless motor according to claim 4, further comprising:
a timing changing unit that delays a switching timing of two phases to which the pulse voltage is applied, from a timing synchronized with a switching timing of which the switching period is the electric angle of 60 degrees, when the electric angle of the switching period is switched to the electric angle of 120 degrees.

7. The drive apparatus for the brushless motor according to claim 1, further comprising:
a duty cycle limiting unit that limits a duty cycle of once in N times of pulse width modulation periods, wherein N is an integer, so that the duty cycle does not decrease below a set value, and that increases the value of N according to a decrease in the rotation speed of the brushless motor.

8. The drive apparatus for the brushless motor according to claim 7, wherein the period changing unit increases the electric angle of the switching period when the rotation speed of the brushless motor cannot be decreased by changing the duty cycle.

9. The drive apparatus for the brushless motor according to claim 1, further comprising:
a second electric angle changing unit that decreases the electric angle of the switching period when a variation of the rotation speed of the brushless motor occurs.

10. The drive apparatus for the brushless motor according to claim 1, wherein the brushless motor is a motor that drives a vehicle oil pump.

11. A drive apparatus for a brushless motor, comprising:
driving means that switches two phases according to position information based on a pulse induced voltage induced in a non-energized phase, the two phases being selected from three phases of the brushless motor and to be applied with a pulse voltage according to a pulse width modulation signal; and
period changing means that changes an electric angle of a switching period of phases to which the pulse voltage is applied, according to a rotation speed of the brushless motor.

12. A drive method for a brushless motor, comprising the steps of:
switching two phases according to position information based on a pulse induced voltage induced in a non-energized phase, the two phases being selected from three phases of the brushless motor and to be applied with a pulse voltage according to a pulse width modulation signal; and
changing an electric angle of a switching period of phases to which the pulse voltage is applied, according to a rotation speed of the brushless motor.

13. The drive method for the brushless motor according to claim 12, wherein the step of changing the electric angle of the switching period comprises the step of:
increasing the electric angle of the switching period when a duty cycle of the pulse width modulation signal decreases to a set value.

14. The drive method for the brushless motor according to claim 12, further comprising the step of:
changing a duty cycle of the pulse width modulation signal when the electric angle of the switching period is changed.

15. The drive method for the brushless motor according to claim 12, wherein the step of changing the electric angle of the switching period comprises the step of:
switching the electric angles of the switching period between 60 degrees and 120 degrees according to the rotation speed of the brushless motor.

16. The drive method for the brushless motor according to claim 12, wherein the step of changing the electric angle of the switching period comprises the step of:
switching the electric angle of the switching period between 60 degrees and 120 degrees according to the rotation speed of the brushless motor,
the drive method further comprising the steps of:
increasing a duty cycle when the electric angle of the switching period is switched from an electric angle of 60 degrees to an electric angle of 120 degrees, and decreasing the duty cycle when the electric angle of the switching period is switched from the electric angle of 120 degrees to the electric angle of 60 degrees.

17. The drive method for the brushless motor according to claim 12, wherein the step of changing the electric angle of the switching period comprises the step of:
switching the electric angle of the switching period is switched between 60 degrees and 120 degrees according to the rotation speed of the brushless motor,
the drive method further comprising the step of:
delaying a switching timing of two phases to which the pulse voltage is applied, from a timing synchronized with a switching timing of which the switching period is the electric angle of 60 degrees, when the electric angle of the switching period is switched to the electric angle of 120 degrees.

18. The drive method for the brushless motor according to claim 12, further comprising the steps of:
limiting a duty cycle of once in N times of pulse width modulation periods, wherein N is an integer, so that the duty cycle does not decrease below a set value; and
increasing the value of N according to a decrease in the rotation speed of the brushless motor.

19. The drive method for the brushless motor according to claim 18, wherein the step of changing the electric angle of the switching period comprises the step of:
increasing the electric angle of the switching period of phases to which the pulse voltage is applied, when the rotation speed of the brushless motor cannot be decreased by changing the duty cycle.

20. The drive method for the brushless motor according to claim 12, further comprising the step of:
decreasing the electric angle of the switching period when a variation of the rotation speed of the brushless motor occurs.
